(19) United States
(12) Patent Application Publication
(10) Pub. No.: US 2018/0094364 A1
(43) Pub. Date: Apr. 5, 2018

(54) CORDS MADE OF CELLULOSIC MULTIFILAMENT YARNS HAVING AN INCREASED LINEAR DENSITY OF INDIVIDUAL FILAMENTS

(71) Applicant: CORDENKA GMBH & CO. KG, Obernburg (DE)

(72) Inventors: Britta ZIMMERER, Amorbach (DE); Kurt UIHLEIN, Grossheubach (DE); Holger SCHEYTT, Erlenbach (DE); Gerold SCHWIERSCH, Erlenbach (DE); Dennis MOESSINGER, Darmstadt (DE)

(73) Assignee: CORDENKA GMBH & CO. KG, Obernburg (DE)

(21) Appl. No.: 15/832,416

(22) Filed: Dec. 5, 2017

Related U.S. Application Data
(62) Division of application No. 13/814,274, filed on Feb. 5, 2013.

(30) Foreign Application Priority Data
Aug. 5, 2010 (EP) 10171956.5
Aug. 5, 2010 (EP) 10171957.3

(51) Int. Cl. D02G 3/48; D01F 2/00; D01F 2/02; D01F 2/06; B60C 9/04; B60C 9/00

(52) U.S. Cl. CPC D02G 3/48; D01F 2/00; D01F 2/02; D01F 2/06; D10B 2201/20; B60C 2009/045; B60C 2009/0035; B60C 2009/0425; Y10T 428/2913

(57) ABSTRACT

A cord, in particular for reinforcing tyres, containing a cellulosic multifilament yarn is disclosed, where the cellulosic multifilament yarn has a strength of at least 35 cN/tex and the individual filaments of the multifilament yarn have a linear density of at least 2.3 dtex. In use, such cords exhibit a significantly improved fatigue behaviour—i.e., a significantly higher fatigue resistance—than standard cords with an individual-filament linear density between 1 and 2 dtex.

The present application is a divisional application of application Ser. No. 13/814,274 filed Feb. 5, 2013, which in turn is a U.S. national stage application of PCT/EP2011/063442 filed Aug. 4, 2011. The entire disclosure of each of the prior applications is incorporated herein by reference in its entirety.

### BACKGROUND

The present invention relates to cords made of cellulosic multifilament yarns having an increased linear density of the individual filaments to improve the fatigue behaviour. Cords made from cellulosic filament yarns are known and are commonly employed as strengthening elements in technical products, e.g. to reinforce elastomer parts and products such as tyre cords, hose reinforcements or as strengthening elements in straps and conveyor belts.

Cellulose is the most frequently encountered and most important naturally occurring polymer. Cellulosic fibres, filaments and multifilaments can be obtained in a wide variety of ways and in different forms which are also known to persons skilled in the art. They can be distinguished by their production method—for example direct solvent processes or regeneration processes—and/or according to the type of product obtained which again consists either of cellulose with a modified crystal structure (“hydrated cellulose”)—for example viscose—or represents a polymer-analogous derivative of cellulose, such as e.g. the known cellulose acetates or cellulose triacetates.

Known direct solvent processes include processes in which the cellulosic fibres are won from solutions in tertiary amine oxides, such as N-methylmorpholine N oxide (NMMO), ionic liquids or even phosphoric acid with subsequent precipitation in suitable coagulation media.

Further common processes for the production of cellulosic filaments which are used in the production of yarn or cord are regeneration processes in which cellulose is first converted chemically into soluble derivatives (xanthates or carbamates) and dissolved. The solution is pumped through spinnerets and finally regenerated to form cellulosic filaments in a coagulation bath. Such filaments are known i.a. under the name rayon. The processes for their production are also known.

Used as carcass fabrics in car tyres, cords produced in this way are subjected to large dynamic loads and high temperatures. In order to satisfy these demands, the cords and the multifilament yarns forming them require high strengths, an outstanding temperature stability and a high fatigue resistance.

WO 2008/143375, for example, describes lyocell-based cellulosic cords having a good fatigue resistance which are made from yarns with a filament count of between 200 and 2000 and a yarn count (=linear density) of 200 to 3000 denier. The filaments have non-round, preferably almost triangular cross-sections.

### SUMMARY

The object of the present invention is thus to provide cellulosic cords having a good fatigue resistance essentially irrespective of the form of the filament cross-section of the multifilament yarns forming the cords, and which are therefore particularly well suited for use as reinforcing cords for motor vehicle tyres.

This object is achieved by an inventive cord containing a cellulosic multifilament yarn characterised in that the cellulosic multifilament yarn has a strength of at least 35 cN/tex and that the individual filaments of the multifilament yarn have a linear density of at least 2.3 dtex.

In the disc fatigue test with compression/elongation settings of −20/+2% and after 855,000 cycles (6 hours)—performed and evaluated in accordance with ASTM D 6588—a cord of this type, for example, with 1840 dtex x1 x2 Z/S 375 (twist factor Tf=185) exhibits a significantly higher fatigue resistance than a cord with the same structure and an individual-filament linear density of 2.0 dtex. The fatigue resistance—measured as the percentage residual strength (PRS)—is thereby higher by a factor of at least 1.1.

Surprisingly this—comparatively small—increase in the individual-filament linear density already results in an improvement in the fatigue resistance and a change in the filament cross-section—as demonstrated by the state-of-the-art—is no longer essential.

Since the individual-filament linear densities of cellulosic multifilament yarns for technical applications generally lie in the range from 1 to 2 dtex, this effect was particularly unexpected.

In particular the individual filaments forming the multifilament yarn of the cord can have a cross-section whose deviation, expressed as the modification ratio (MR), is smaller than 1.1. The modification ratio is described, for example, in WO 2008/143375 and expresses the quotient of two radii of the filament cross-section (R1/R2), where the radius R2 describes the largest possible circle lying within the filament cross-section, and the radius R1 the radius of the smallest possible circle that can be placed around the filament cross-section. In the case of an ideal circular cross-section, R1 and R2 are identical so that the modification ratio MR is 1.

### BRIEF DESCRIPTION OF THE DRAWINGS

FIG. 1 illustrates the influence of the individual-filament linear density on the fatigue behaviour of a cord with the construction 1840 dtex x1 x2 Z/S 375 in the disc fatigue test +2%/−20% elongation/compression after 6 hours (=855,000 cycles).

FIG. 2 illustrate the influence of the filament count on the fatigue behaviour taking the example 1660 dtex (f720) x1 x2 with 2.31 dtex compared with 1840 dtex (f1000) x1 x2 with 1.84 dtex individual-filament linear density.

FIG. 3 is a comparison of 1220 dtex x1 x2 cords with variation of the nominal individual-filament linear density from 1.69 dtex (f720) to 2.71 dtex (f450).

FIG. 4 illustrates the behavior of lyocell cords with the constructions 1840 dtex x1 x2, Z/S 360 and 420 with different individual-filament linear densities.

### DETAILED DESCRIPTION OF EMBODIMENTS

The multifilament yarn (referred to within the context of this application also simply as yarn) in the inventive cords has a strength preferably higher than 35 cN/tex (conditioned according to BISFA), more preferably higher than 40 cN/tex, even more preferably higher than 45 cN/tex and most preferably higher than 50 cN/tex. In general the strength limit for cellulosic multifilament yarns lies in the order of 90 cN/tex.

The multifilament yarn has an individual-filament linear density higher than 2.3 dtex, preferably higher than 2.7 dtex, more preferably higher than 3.2 dtex, most preferably higher than 4.0 dtex to a maximum of approximately 8 dtex. It can consist of a random number of endless (continuous) filaments such as are common in technical products. As a rule the yarn has an overall linear density in the range from 30 to 20000 dtex and consists of 10 to 5000 filaments. The elongation at break of the yarn is 5 to 20%, preferably 7 to 16%.

The determining factor is the “nominal individual-filament linear density”, i.e. the overall linear density of the untwisted yarn divided by the number of individual filaments. The “nominal individual-filament linear density” is determined in untwisted state because a contraction in length generally occurs during twisting. The basis for determining the overall linear density of the untwisted yarn is the BISFA standard (“Testing methods for viscose, cupro, acetate, triacetate and lyocell filament yarns”, 2007 edition).

The yarn preferably contains at least 80 wt. % cellulose, preferably at least 90 wt. % and more preferably at least 95 wt % cellulose.

The yarn can be wound to form a yarn coil in untwisted state or with a protective twist. The resulting yarn coils are particularly suitable as starting material for the production of cords for use as reinforcing components for natural and synthetic elastomers, thermoplastics and duromers.

Processing to form the inventive reinforcement cords normally takes place by twisting one or more multifilament yarns, at least one of which is made partly or completely from filaments with an individual-filament linear density lying within the above limits. In one embodiment of the invention, the cord is produced by twisting multifilament yarns all of which are made from filaments with an individual-filament linear density lying within the above limits.

The yarn can be combined with other yarns, such as yarns of polyamide, aramid, polyester, regenerated cellulose, glass, steel and carbon. In twisted or untwisted state, the yarn can be processed, for example, together with viscose filament yarn, nylon 6 and/or nylon 66 to form a cord. The yarns with which the inventive yarn is combined can be preimpregnated or non-preimpregnated.

The yarn can be used alone, as chopped fibres or after processing to form a cord or after subsequent processing to form a woven or knitted fabric, as a reinforcement material for synthetic and natural elastomers, or for other materials (synthetic or based on renewable raw materials), for example for thermoplastic and thermosetting polymers.

Examples of these materials include natural rubber, other poly(isoprene)s, poly(butadiene)s, polyisobutylenes, butyl rubber, poly(butadiene co-styrene)s, poly(butadiene coacrylnitrile)s, poly(ethylene co-propylene)s, poly(isobutylene co-isoprene)s, poly(chloroprene)s, polyacrylates, polyurethanes, polysulphides, silicones, polyvinyl chloride, poly(ether-ester) cross-linked unsaturated polyester, epoxy resins or blends of the above.

### Explanations of the Fatigue Behaviour and of the Test Method

In order to compare cords with different overall linear densities, the same twist factor (T_{f}, linear-density-standardised cord twist) should be used for the assessment of the fatigue behaviour. The twist factor T_{f} is defined as:

$${T}_{f} = \frac{n}{100} \cdot \sqrt{\frac{{LD}_{cord} [ dtex ]}{ρ [ g {cm}^{- 3} ]}}$$

(n: cord twist in tpm (turns per metre); LD: overall linear density in dtex; ρ: density of the material, for rayon 1.51 g/cm³)

During the fatigue tests it must generally be considered that a higher twist results in a better fatigue resistance and hence a lower loss of strength. A higher twist, however, results in a different force/elongation curve for the cord and in lower cord strengths. For technical applications, a comprise therefore always has to be found between minimum cord twist and maximum fatigue resistance. The minimum cord twist is selected such that the cord is still on a “stability plateau” on which it still exhibits an uncritical fatigue behaviour. A cord with improved fatigue behaviour with identical cord twist is a crucial advantage for technical applications because then higher strengths or the use of less material can be achieved in the component.

The fatigue behaviour of the cord is evaluated using the percental retained strength (PRS) by comparing the residual strength of a test specimen (cord vulcanised in a rubber block) after a fatigue programme with the unloaded (reference) test specimen (“virgin sample”):

PRS [%]=(residual strength/strength of reference test specimen)*100.

The fatigue test programme, also known as the disc fatigue load or GBF (Goodrich Block Fatigue), is performed in accordance with ASTM D6588 and ASTM D885-62T. The percental retained strength is consequently referred to as GBF-PRS. In order to obtain differentiated values for the fatigue behaviour of cords, the test specimens are now subjected to such dynamic loads that after the loading programme they exhibit GBF-PRS values of only 40-90%, i.e. lying outside the above-mentioned stability plateau (recommended in ASTM D885T-62T). For cellulosic cords with a twist factor of less than 200, GBF-PRS values of 40-70% are typically observed after loading with +2% elongation/−20% compression for 6 hours at 2375 rpm. In this loading programme, a twist factor of 200 generally marks the lower edge of the stability plateau. Below this limit, a wide spreading of the retained strengths of different cord specimens occurs which can thus be differentiated and classified according to their fatigue resistance.

### Production Process:

In order to produce the inventive multifilament yarns with increased linear density of the individual filaments and at the same time high strength, the number of spinnerets is reduced and the spinneret diameter modified so that despite a high mass flow rate, the discharge rate remains comparable with that for the production method for the individual-filament linear density of 2.0 dtex with an identical overall mass flow rate. As the precipitation process is determined by diffusion, the upper limit of the individual-filament linear density for cost-effective production processes is limited to 8 dtex.

A tyre cord with the construction 1840 dtex x1 x2 Z/S 375 consists of two twisted single multifilament yarns each with an overall linear density of 1840 dtex. The two multifilament yarns each have 375 twists (Z twist) per metre, the cord is twisted with S 375 per metre.

The nominal overall or individual-filament linear densities are shown in each case in the examples.

The invention is explained in greater detail using the following examples where the respective nominal overall and individual-filament linear densities are shown in each case.

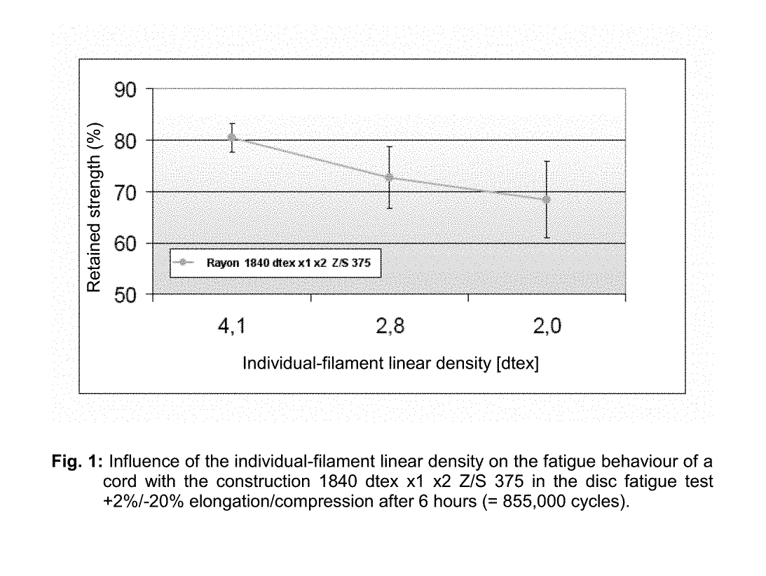

FIG. 1 shows in summary the dependence of the retained strength of a standard rayon type 1840 dtex x1 x2 Z/S 375 after fatigue over 855,000 cycles (6 hours) with 2% elongation and −20% compression. Even allowing for the fluctuation range, the advantage of the inventive cords for reducing the fatigue can be clearly recognized.

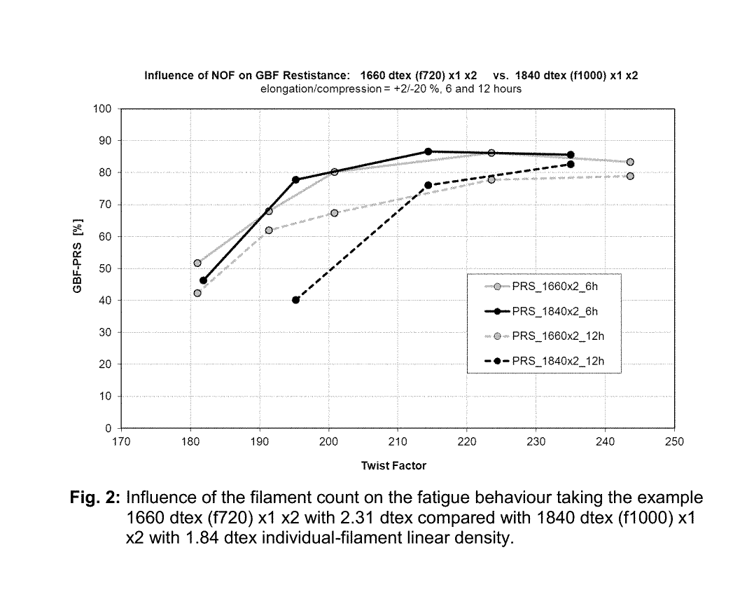

FIG. 2 shows the comparison of the cord types 1840 dtex (f1000) x1 x2 vs. 1660 dtex (f720) x1 x2 dtex with their respective nominal individual-filament linear densities: 1.84 dtex vs. 2.31 dtex. From the linear-density-standardised plot (PRS vs. twist factor) it can be seen that after 6 hours (855,000 cycles) of disc fatigue loading (+2% elongation/−20% compression), the two types are still comparable, but that after 12 hours the 1660 dtex x1 x2 cord with its 2.31 dtex individual filaments is superior.

Higher overall linear densities normally result in a better fatigue behaviour. The higher overall linear density of the 1840 dtex x1 x2 cord can be compensated in the case of the 1660 dtex x1 x2 cord (FIG. 2) by a higher individual-filament linear density so that a comparable or better fatigue resistance can be achieved as a result. The positive influence of the thicker individual filament becomes stronger with increasing duration of the fatigue test.

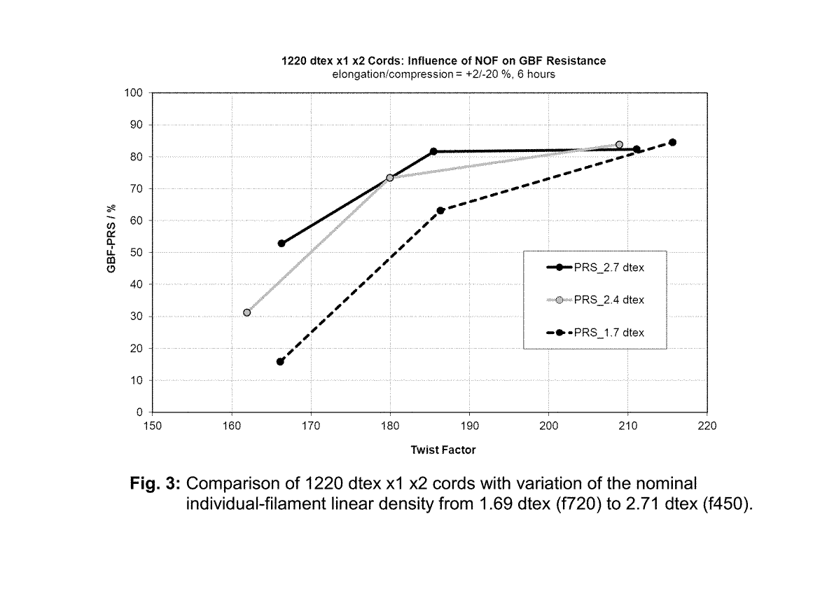

FIG. 3 shows for rayon 1220 dtex x1 x2 cords the fatigue behaviour as a function of the nominal individual-filament linear densities in the range from 1.69 dtex (f720) to 2.71 dtex (f450). The best fatigue behaviour is exhibited by the cord with a nominal individual-filament linear density of 2.71 dtex (f450).

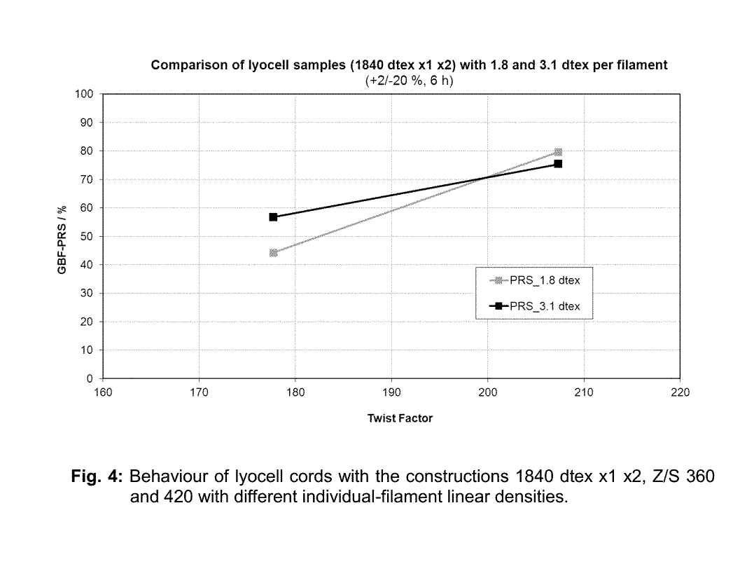

FIG. 4 shows for the example of 1840 dtex x1 x2 cords that multifilament fibres produced in the direct solvent process (NMMO) also exhibit an increased fatigue resistance of the thick individual filament (3.1 dtex). The determining factor for this again is the critical fatigue range outside the stability level (T_{f}<200).

1. A process for increasing the fatigue resistance of a cord comprising forming a cord from one or more cellulosic multifilament yarns by twisting, wherein the one or more cellulosic multifilament yarns have a strength of at least 35 cN/tex and individual filaments of the one or more cellulosic multifilament yarns have a linear density of at least 2.3 dtex, such that a cord construction with a twist factor of Tf=185 in a disc fatigue test with compression/elongation settings of −20/+2% and 855,000 cycles, performed and evaluated in accordance with ASTM D 6588, exhibits a higher fatigue resistance by a factor of at least 1.1 than a cord with a same twist factor and an individual-filament linear density of 2.0 dtex.

2. The process according to claim 1, wherein the individual filaments of the one or more cellulosic multifilament yarns have a linear density of at least 2.7 dtex.

3. The process according to claim 1, wherein the one or more cellulosic multifilament yarns have a strength of at least 40 cN/tex.

4. The process according to claim 1, wherein the one or more cellulosic multifilament yarns are prepared by a regeneration process.

5. The process according to claim 4, wherein the one or more cellulosic multifilament yarns are rayon yarns.

6. The process according to claim 1, wherein the one or more cellulosic multifilament yarns are prepared by a direct solvent process.

7. The process according to claim 6, wherein the one or more cellulosic multifilament yarns are prepared by the direct solvent process in tertiary amine oxide or in ionic liquids.

8. The process according to claim 1, wherein in producing the one or more cellulosic multifilament yarns, a number of spinnerets is reduced and at the same time a spinneret diameter is modified so that an overall mass flow rate remains identical as with an individual filament having a linear density of 2.0 dtex.
